(19) United States
(12) Patent Application Publication
(10) Pub. No.: US 2008/0080303 A1
(43) Pub. Date: Apr. 3, 2008

(54) FLUID MIXER, FLUID MIXING APPARATUS, AND NOZZLE MEMBER

(75) Inventor: Hisao KOJIMA, Yokohama-shi (JP)

Correspondence Address: DITTHAVONG MORI & STEINER, P.C., 918 Prince St., Alexandria, VA, 22314, US

(73) Assignee: Anemos Company Ltd., Tokyo (JP)

(21) Appl. No.: 11/866,050

(22) Filed: Oct. 2, 2007

(30) Foreign Application Priority Data
Oct. 3, 2006 (JP) 2006-272197

(51) Int. Cl. B01F 15/04

(52) U.S. Cl. 366/160.1

(57) ABSTRACT

Disclosed is a fluid mixer for mixing fluids of different types having a tube member in which a mixing portion for mixing the fluids of different types is installed and a nozzle member for introducing a fluid into the tube member. The nozzle member inn the fluid mixer includes a varying portion for varying a fluid flow.

### CROSS REFERENCES TO RELATED APPLICATIONS

The present invention contains subject matter related to Japanese Patent Application JP 2006-272197 filed in the Japanese Patent Office on Oct. 3, 2006, the entire contents of which being incorporated herein by reference.

### BACKGROUND OF THE INVENTION

1. Field of the Invention

The present invention relates to a fluid mixer for mixing different fluids. In particular, the present invention relates to a fluid mixer for use in treating water, such as industrial waste water, public and sewage water, an individual pond, a river, and ground water; removal and recovery of heterogeneous materials in gas; a bioreactor; and the like. In addition, the present invention relates to a fluid mixing apparatus using such a fluid mixer. Furthermore, the present invention relates to a nozzle member used in such a mixing apparatus.

2. Description of the Related Art

The related-art fluid mixer mixes, stirs, and contacts fluids of different types in a mixing portion installed therein. For increasing the efficiencies of such treatments, it has been known that the negative pressure effect of the inside of a mixer is enhanced by an increase in flow rate of one of fluids and the volume of another fluid introduced from the outside is then increased to enhance the treatment (mixing) efficiency. One of the techniques to increase the efficiencies of such treatments, for example, Japanese Unexamined Patent Application Publication No. 2001-62269 proposes that the installation of a tubular nozzle in the fluid mixer allows a fluid to be introduced through the nozzle, and hence the flow rate of the fluid can be increased.

### SUMMARY OF THE INVENTION

However, the installation of the tubular nozzle in the fluid mixer decreases the distance between the leading end portion of the nozzle and the mixing portion. Accordingly, before the introduction of the fluid into the mixing portion, the extent of mixing or contacting the fluid introduced from the nozzle with another fluid introduced by the negative pressure effect is decreased. Thus, the efficiencies of treatments, such as mix, stir, and contact in the mixing portion may be decreased. Further, since the fluid mixer includes semielliptical blades therein, the flow rate of introducing fluid is limited to approximately 2 m/sec. or less, thereby also decreasing mixing efficiency.

In view of such consequences as described above, embodiments of the present invention provides a fluid mixer, a fluid mixing apparatus, and a nozzle member capable of increasing the flow rate of a fluid introduced into the fluid mixer to enhance a negative pressure effect while maintaining the treatment efficiency of a mixing portion.

According to embodiments of the present invention, there are provided following inventions (1) to (11):

(1) According to an embodiment of the present invention, a fluid mixer for mixing fluids of different types includes a tube member in which a mixing portion for mixing the fluids of different types is installed; and a nozzle member for introducing a fluid into the tube member, where the nozzle member includes a varying portion for varying a fluid flow.

(2) According to the fluid mixer of the embodiment of the present invention, one end of the nozzle member is located in the vicinity of the mixing portion.

(3) According to the fluid mixer of the embodiment of the present invention, the varying portion includes spiral blades provided along an inner peripheral surface of the nozzle member.

(4) According to the fluid mixer of the embodiment, the number of the spiral blades is two or more.

(5) According to the fluid mixer of the embodiment, the two or more blades are arranged at equal intervals along the inner peripheral wall of the nozzle member.

(6) According to the fluid mixer of the embodiment, the tube member includes a pore for introducing the fluid into the tube member.

(7) According to an embodiment of the present invention, the fluid mixer further includes a coupling member to couple the tube member and the nozzle member, and the coupling member includes a pore for introducing fluids thereinto.

(8) According to an embodiment of the present invention, a fluid mixing apparatus includes a fluid mixer for mixing fluids of different types; a first feeding portion for feeding a fluid into the fluid mixer; and a second feeding portion for feeding a fluid differing in type from the fluid into the fluid mixer, where the fluid mixer includes a tube member in which a mixing portion for mixing the fluids of different types is installed, and a nozzle member for introducing a fluid into the tube member, with the nozzle member having a varying portion for varying a fluid flow.

(9) According to an embodiment of the present invention, a nozzle member used in a fluid mixer for mixing fluids of different types and for introducing a fluid into the fluid mixer includes a varying portion for varying a fluid flow, and an inlet for introducing a fluid into the fluid mixer.

(10) According to the nozzle member of the embodiment, the varying portion includes spiral blades provided along an inner peripheral surface of the nozzle member.

(11) According to the nozzle member of the embodiment, the number of the spiral blades is two or more.

(12) According to the nozzle member of the embodiment, the two or more blades are arranged at equal intervals along the inner peripheral wall of the nozzle member.

According to the fluid mixer of an embodiment of the present invention, the blade included in the varying portion causes varied and turbulent streamlines of the fluid flowing through the nozzle member. Consequently, the flow rate of the fluid introduced in the mixer can be maintained in large and facilitate the fluid to be easily mixed with fluids of other types, thereby enhancing the efficiencies of treating (mixing) the fluids in the mixing portion of the fluid mixer.

According to the embodiment of the present invention, the blade included in the varying portion causes varied and turbulent streamlines of the fluid flowing through the nozzle member. Consequently, the flow rate of the fluid introduced in the mixer can be maintained in large and facilitate the fluid to be easily mixed with fluids of other types, thereby enhancing the efficiencies of treating (mixing) the fluids in the mixing portion of the fluid mixer and enhancing the mixing efficiencies of the fluid mixing apparatus.

According to the nozzle member of an embodiment of the present invention, the blade included in the varying portion causes varied and turbulent streamlines of the fluid flowing through the inside of the nozzle member. Consequently, the flow rate of the fluid introduced in the mixer can be maintained in large and facilitate the fluid to be easily mixed with fluids of other types, thereby enhancing the efficiencies of treating (mixing) the fluids in the mixing portion of the fluid mixer using the nozzle member. The flow rate of fluid at the mixing portion of the fluid mixer is preferably in a range of approximately 2 m/sec. to 12 m/sec., and more preferably in a range of approximately 3 m/sec. to 8 m/sec.

### BRIEF DESCRIPTION OF THE DRAWINGS

FIG. 1 is a schematic diagram illustrating the configuration of a fluid mixer in accordance with an embodiment of the present invention;

FIG. 2 is a schematic cross-sectional perspective diagram illustrating the fluid mixer of the embodiment of the present invention;

FIGS. 3A, 3B are schematic diagrams illustrating the configuration of a fluid mixer in accordance with an embodiment of the present invention;

FIG. 4 is a schematic diagram illustrating the configuration of a nozzle tube in accordance with an embodiment of the present invention;

FIG. 5 is a schematic cross-sectional perspective diagram illustrating the nozzle tube of the embodiment of the present invention;

FIGS. 6A to 6C are plan views of nozzle tubes in accordance with a plurality of embodiments of the present invention viewing from the inlet side, where FIG. 6A, FIG. 6B, and FIG. 6C show the nozzle tubes of different embodiments, respectively;

FIG. 7 is a block diagram illustrating a fluid mixing apparatus that carries out an aeration treatment of activated sludge to which the fluid mixer of the present invention is applied;

FIG. 8 is a block diagram illustrating an fluid mixing apparatus in accordance with one embodiment of the present invention; and

FIG. 9 is a block diagram illustrating a fluid mixing apparatus that carries out an aeration treatment of lake water, to which the fluid mixer of the present invention is applied;

FIG. 10 is a schematic cross-sectional perspective diagram illustrating the fluid mixer of the embodiment of the present invention;

FIG. 11 is a schematic cross-sectional perspective diagram illustrating the fluid mixer of the embodiment of the present invention;

FIG. 12A, 12B are schematic cross-sectional perspective diagrams illustrating a coupling member employed in the fluid mixer of the embodiment of the present invention;

FIGS. 13A, 13B are schematic cross-sectional perspective diagrams illustrating a coupling member employed in the fluid mixer of the embodiment of the present invention.

### DESCRIPTION OF THE PREFERRED EMBODIMENTS

Hereinafter, fluid mixers in accordance with embodiments of the present invention will be described with reference to attached drawings. However, the present invention is not limited to the following embodiments. Nozzle members in accordance with embodiments of the present invention will also be described with the fluid mixers.

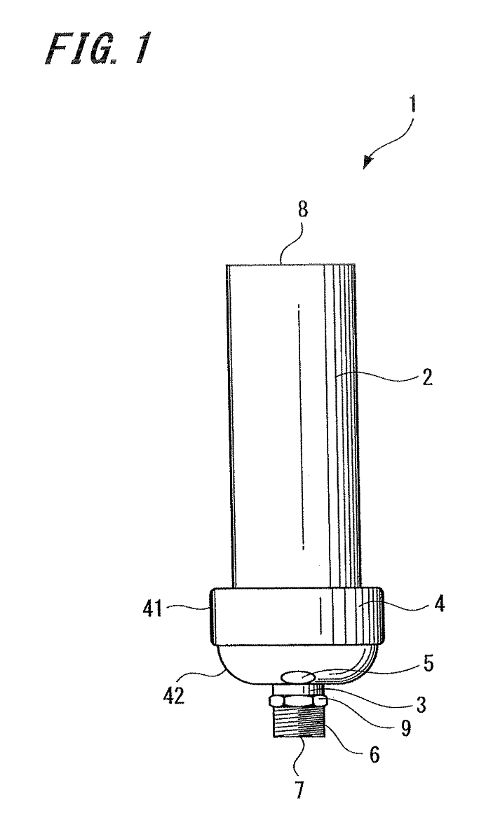

FIG. 1 is a schematic diagram illustrating the configuration of a fluid mixer 1 in accordance with one embodiment of the present invention.

As shown in FIG. 1, the fluid mixer 1 of the present embodiment includes a passage tube 2, a nozzle tube 3, and a coupling member 4 connecting the passage tube 2 and the nozzle tube 3.

The passage tube 2 includes a cylindrical tube member having a fluid passage inside thereof. An exhaust 8 is formed in one end (upper part) of the passage tube 2 and responsible for discharging a fluid passed through the inside of the passage tube to the outside.

The nozzle tube 3 includes a cylindrical tube member having a fluid passage inside thereof. A threaded portion 6 is provided in the outer peripheral portion of one end (lower part) of the nozzle tube 3. For example, the threaded portion 6 may be threadably attached to a threaded hole formed in a gas-supplying tube for supplying a gas from the outside to the fluid mixer to communicate between the gas-supplying tube and the nozzle tube. An inlet 7 for introducing a fluid into the fluid mixer 1 is formed in one end (lower part) of the nozzle tube 3. In addition, the nozzle tube 3 includes a nut portion 9 for thread-fastening.

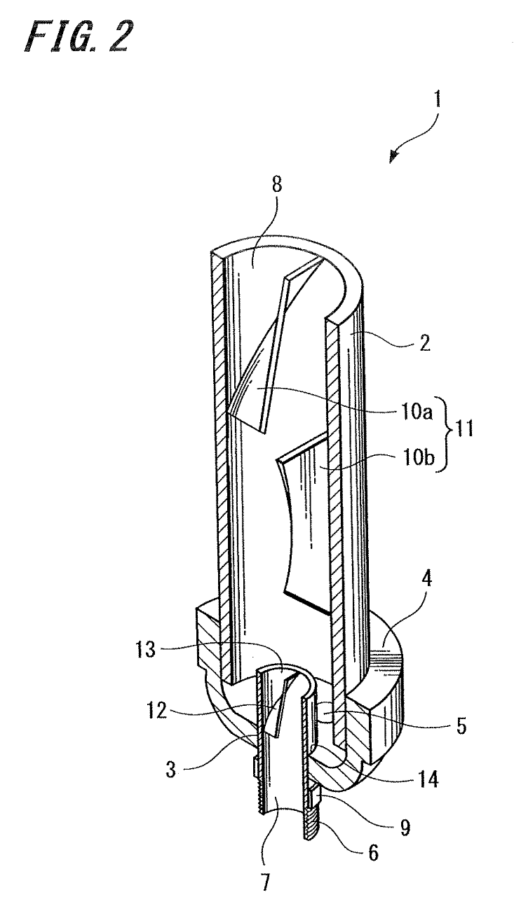

The coupling member 4 includes an annular portion 41 and a bottom portion 42 having an approximately hemispherical shape that is provided adjacent to the annular portion 41. In the bottom portion 42, a plurality of inlet pores 5 for introducing a fluid into the fluid mixer 1 is formed. In addition, an insertion hole (see the reference numeral 14 in FIG. 2) is formed in the center of the bottom portion 42.

The fluid mixer 1 is assembled such that the other end (lower part) of the passage tube 2 is inserted into the annular portion 41 of the coupling member 4 and fixed therein, while the other end (upper part) of the nozzle tube 3 is inserted into the insertion hole of the coupling member 4 and fixed therein.

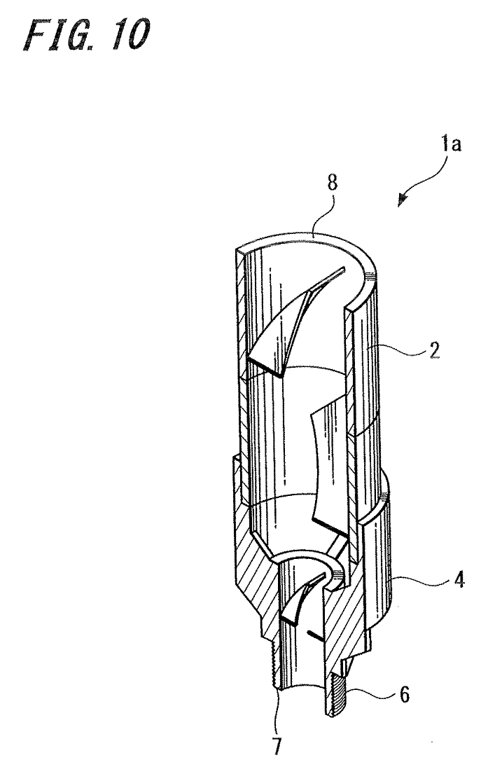

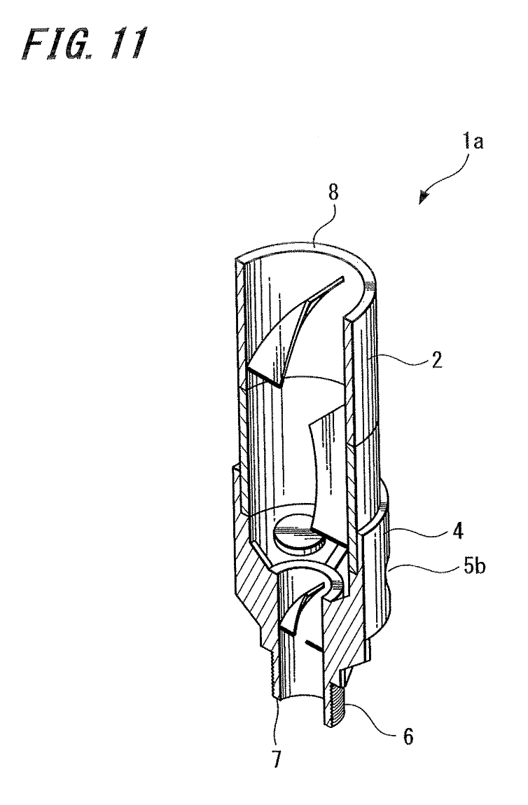

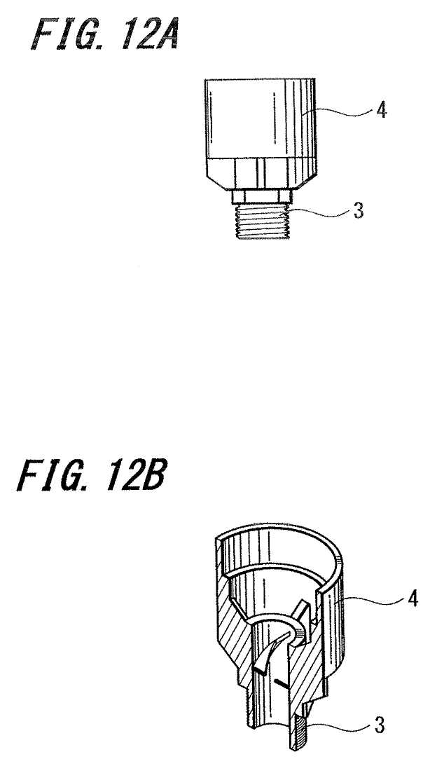

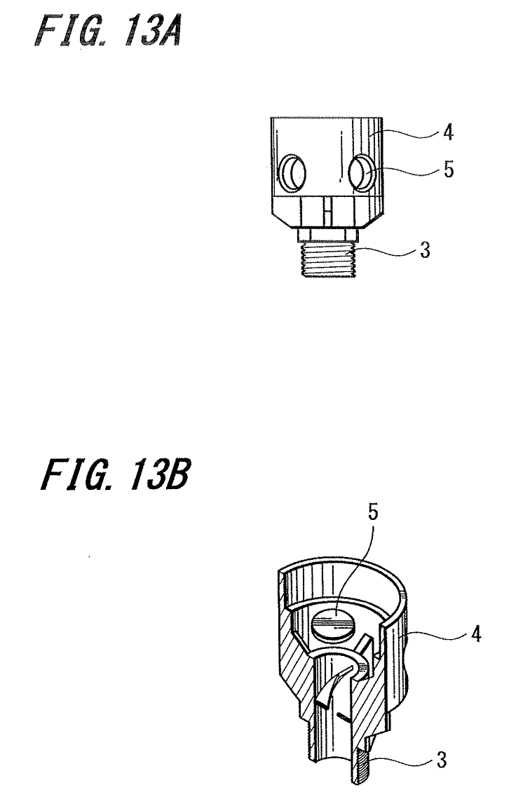

The inlet pores 5 are not limited to those of the present embodiment. For instance, the coupling member 4 may include a plurality of lib-shaped members and the gap between the adjacent lib-shaped members may be used as an inlet pore. Alternatively, the nozzle tube 3 and the coupling member 4 may be integrally molded by injection molding or lost-wax casting process to form a fluid mixer shown in FIG. 10 or FIG. 11. As shown in FIGS. 12A and 12B, the nozzle tube 3 is integrally formed in the coupling member 4 in the fluid mixer 1 shown in FIG. 10. As shown in FIGS. 13A and 13B, the nozzle tube 3 is integrally formed in the coupling member 4, in which an inlet pore 5b is then additionally formed as shown in FIGS. 13A and 13B.

FIG. 2 is a schematic cross-sectional perspective diagram illustrating a fluid mixer 1 in accordance with an embodiment of the present invention.

In FIG. 2, portions corresponding to those of FIG. 1 are denoted by the same reference numerals to omit the description thereof.

A mixing portion 11 including blades 10a and 10b is formed in a passage tube 2. The blade 10a is formed in the shape of a left-twisted spiral and the blade 10b is formed in the shape of a right-twisted spiral. In other words, the blades 10a and 10b are formed so that the directions of the spirals differ from each other.

The blades 10a and 10b are formed on the inner peripheral surface of the passage tube 2 and arranged at positions so that the heights thereof are different from each other. In this embodiment, a left-twisted spiral blade (not shown) is formed at a position symmetric to the blade 10a. Similarly, a right-twisted spiral blade (not shown) is formed at a position symmetric to the blade 10b. Furthermore, a passage is formed between the blades so that a fluid can flow along the central axis of the passage tube 2. In addition, a plurality of through-holes may be formed in each of the blades 10a and 10b.

According to the present embodiment, types of blades 10 installed in the passage tube 2 may be a combination of a left-twisted spiral blade and a right-twisted spiral blade. However, the present invention is not limited to such a combination. An additional right-twisted spiral blade may be placed above the left-twisted blade 10a to form a triad of a triad of right-, left-, and right-twisted spiral blades. However, the number of types of the spiral blades in the combination is not limited thereto. The number of types of the spiral blades in the combination may be four or more. Alternatively, the types of blades 10 may be a combination of a right-twisted spiral blade and a left-twisted spiral blade in place of the combination of a left-twisted spiral blade and the right-twisted spiral blade.

The forms of the respective members constituting the mixing portion 11 are not limited to the blades. For example, two or more convex members may be formed on the inner peripheral surface of the passage tube 2.

The other end (upper part) of the nozzle tube 3 inserted in the insertion hole 14 of the coupling member 4 is formed to extend toward the vicinity of the blade 10b. In other words, an outlet 13 formed in the other end (upper part) of the nozzle tube 3 is located in the vicinity of the mixing portion 11. In addition, spiral blades 12 are formed in the other end of the nozzle tube 3 to form a varying portion as described later.

The blades 12 of the present embodiment are in the shape of a left-twisted spiral and formed on the inner peripheral surface of the nozzle tube 3. At a position symmetric to the blade 12, a left-twisted spiral blade is provided (not shown). A pore portion 16 is formed between the blades 12. The pore portion 16 is provided as a passage through which a fluid flows along the central axis of the nozzle tube 3. In addition, the fluid passage is located on the same axis as that of the fluid passage formed between the blades 10 of the passage tube 2.

Furthermore, in the present embodiment, the blade 12 in the nozzle tube 3 spins or twists in the left-handed direction. The spiral of the blade 10b in the passage tube 2 located above the blade 12 is in the right-handed direction and the spiral of blade 10a is in the left-handed direction. In this way, since the blades installed in the fixing mixer 1 are arranged so that the directions of the blades are alternately different along the direction of the fluid, the directions of the fluids introduced from the inlet 7 of the nozzle tube 3 alternately vary to enhance the efficiencies of mixing the fluids in the mixer. The spiral directions of the respective blades may be alternately differed. If the spiral direction of the blade 12 in the nozzle tube 3 is right-twisted, the blade 10b may be left-twisted spiral and the blade 10a may be right-twisted spiral. Furthermore, for improving the mixing efficiencies by varying the flows of the fluid, a plurality of the through-holes may be formed in the blades 10 and 12.

Furthermore, the spin direction or twist direction of the spiral of the blade 12 in the nozzle tube 3 is set in the left-handed direction to torque the nozzle tube 3 in the left-handed direction with respect to the inlet 7. Consequently, an engaged portion between the threaded portion 6 of the nozzle tube 3 grooved in the right direction and a supplying pipe for supplying a fluid is provided with force to constantly tighten the nozzle tube. Thus, the introduction of a fluid into the nozzle tube 3 can prevent the mixer 1 from coming off from the supplying pipe.

Furthermore, a predetermined space is formed between the outlet 13 of the nozzle tube 3 and the bottom end of the blade 10b. A negative pressure effect of a fluid (e.g., gas) emitted from the outlets 13 of the nozzle tube 3 may draw a fluid of another type (e.g., liquid) from inlet pores 5 formed in the coupling member 4, thereby introducing both the liquid and the gas into the mixing portion 11 of the passage tube 2.

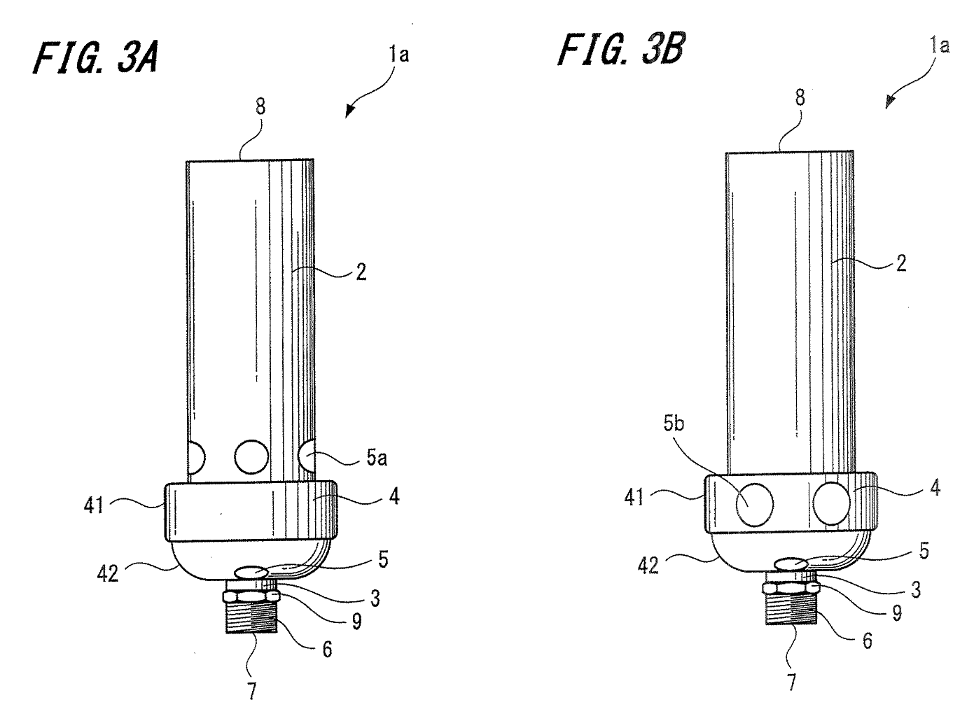

FIGS. 3A and 3B are schematic diagrams illustrating the configuration of a fluid mixer 1a in accordance with another embodiment of the present invention.

As shown in FIG. 3A, a passage tube 2 of the fluid mixer 1a in accordance with the embodiment includes inlet pores 5a for introducing a fluid into the passage tube 2. The inlet pores 5a are arranged at equal intervals along the peripheral wall of the passage tube 2. Alternatively, the inlet pores 5a may be arranged such that a plurality of lines is formed in the longitudinal direction of the passage tube 2. In addition, a plurality of inlet pores 5b may be arranged along the peripheral wall of the coupling member 4 in the axis direction. With such arrangements, the amount of fluids introduced from the inlet pores 5b will be increased, thereby enhancing mixing efficiency.

In this way, the formation of inlet pores 5a in the peripheral wall of the passage tube 2 allows a fluid to be drawn into the passage tube 2. Thus, the mixing efficiencies of fluids of different types in the fluid mixer 1a can be enhanced. Furthermore, the formation of a plurality of inlet pores 5a can increase the amount of a fluid drawn into the passage tube 2. As shown in FIG. 3B, the inlet pores 5b may be formed along the peripheral wall of the coupling member 4.

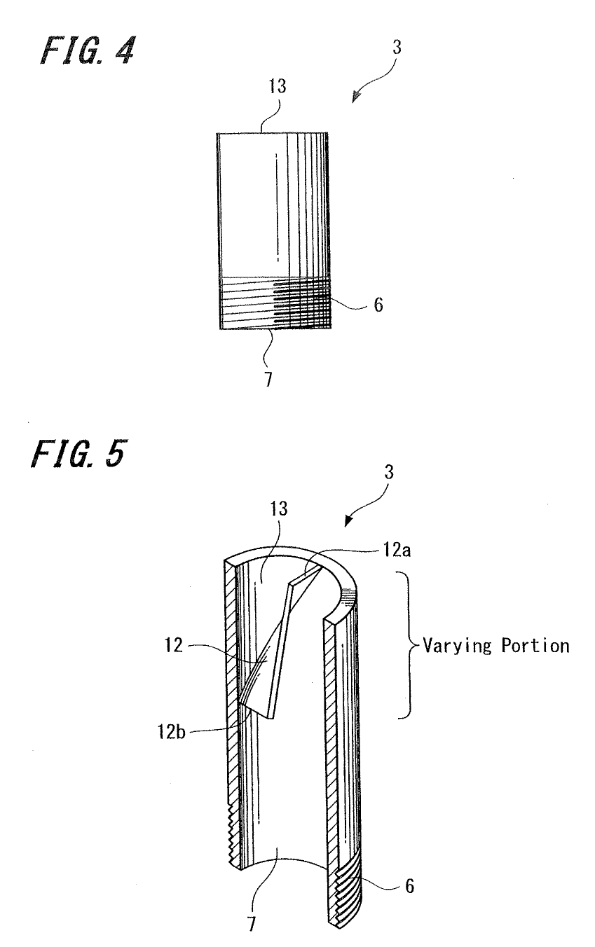

FIG. 4 is a schematic diagram illustrating the configuration of the nozzle tube 3 in accordance with the embodiment of the present invention. As shown in FIG. 4, the nozzle tube 3 includes a cylindrical tube member having a fluid passage therein. An inlet 7 for introducing a fluid into the nozzle 3 is formed in one end of the nozzle tube 3. An outlet 13 for injecting a fluid into the fluid mixer is formed in the other end of the nozzle tube 3. Furthermore, a plurality of grooves is provided in the outer peripheral portion of the end of the nozzle tube 3 at the side of the inlet 7. The nozzle tube 3 is attached to the fluid mixer 1 such that the nozzle tube 3 is inserted into the insertion hole 14 formed in the direction from the end of the outlet 13 to the coupling member 4.

FIG. 5 is a schematic cross sectional perspective diagram of the nozzle tube 3 in accordance with the embodiment of the present invention.

As shown in FIG. 5, a spirally-twisted blade 12 is provided inside of the nozzle tube 3 to form a varying portion. A fluid introduced from an inlet 7 into the nozzle tube 3 collides with the blade 12 and is then sheared, thereby changing flow direction to cause a vortex flow. Consequently, the fluid discharged from the outlet 13 into the fluid mixer 1 changes to a turbulent flow. Thus, the fluid can be easily mixed with a fluid of another type. Even in the case that the distance between the outlet 13 of the nozzle tube 3 and the mixing portion 11 formed on the passage tube 2 is short, the fluids of different types can be efficiently mixed. The flow rate of fluid introduced from the inlet 7 into the nozzle tube 3 is preferably in a range of approximately 10 m/sec. to 100 m/sec., and more preferably in a range of approximately 20 m/sec. to 60 m/sec.

Furthermore, the blade 12 is formed in the shape of a spiral such that the edge 12a of the blade 12 at the side of the outlet 13 and the edge 12b thereof at the side of the inlet 7 are crossed at an angle of approximately 90 degrees.

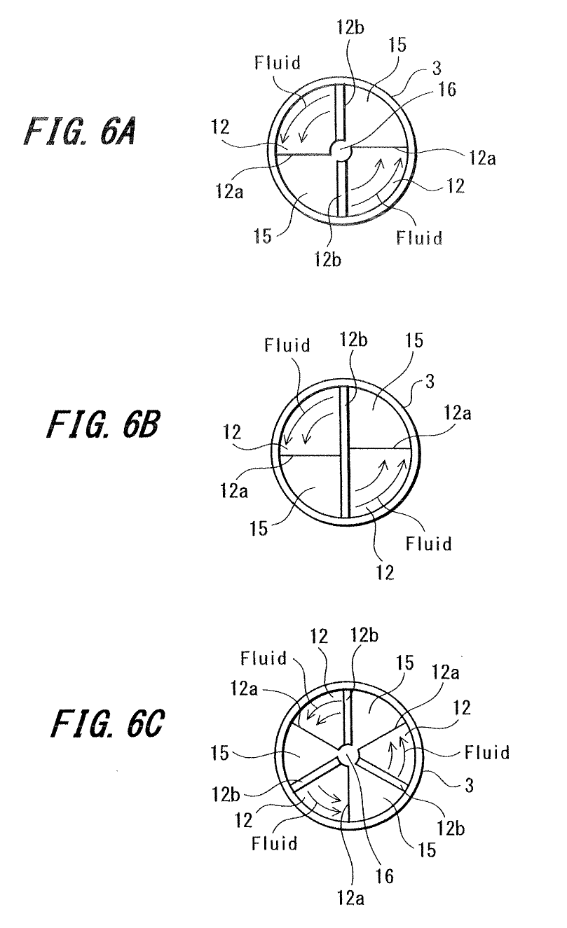

FIG. 6A is a plan view of a nozzle tube in accordance with the embodiment of the present invention from the inlet 7.

As shown in FIG. 6A, blades 12 formed in the nozzle tube 3 include two blades and the spin or twist directions of the respective spirals are in the left-handed direction. The edge 12b of one blade 12 at the inlet 7 side is separated from that of the other blade, so that a pore portion 16 is formed as a fluid passage in the direction along the center axis of the nozzle tube 3. Each of the blades 12 has a twist angle of approximately 90 degrees and the blades 12 are located at positions along the inner peripheral surface of the nozzle tube 3 and symmetric to each other with respect to the center axis of the nozzle tube 3. Furthermore, two fluid passages 15 are formed between the blades 12 in the inner peripheral direction. The fluid passages 15 communicate with the pore portion 16. A fluid introduced from the inlet 7 into the nozzle tube 3 collides with the blades 12 and is then sheared and flows along the twisted portions of the blades 12 as indicated by arrows in the figure. In other words, a fluid introduced from the inlet 7 into the nozzle tube 3 passes through the fluid passages 15 and the pore portion 16 while the flow of the fluid is being varied. Subsequently, the fluid is discharged from the outlet 13 into the fluid mixer 1 (mixing portion 11).

FIG. 6B is a plan view of a nozzle tube in accordance with another embodiment of the present invention from an outlet 13.

As shown in FIG. 6B, a nozzle tube 3 includes a single blade 12. The edge 12b of the blade at the side of the inlet 7 is integrally formed in the direction along the diameter of the nozzle tube 3. The blade 12 has a twist angle of approximately 90 degrees and forms two fluid passages 15 in the inner peripheral direction of the nozzle tube 3. A fluid introduced from the inlet 7 into the nozzle 3 passes through the fluid passages 15 while the flow thereof is being varied by the blade 12. Subsequently, the fluid is discharged from the outlet 13 into the fluid mixer 1 (mixing portion 11).

FIG. 6C is a plan view of a nozzle tube in accordance with another embodiment of the present invention from the outlet 13.

As shown in FIG. 6C, a nozzle tube 3 includes three blades 12. The edges 12b of the respective blades 12 at the inlet side are separated from one another. A pore portion 16 is formed as a fluid passage in the direction along the center-axis of the nozzle tube 3. Each of the blades 12 has a twist angle of approximately 60 degrees and the blades 12 are arranged at equal intervals along the inner peripheral wall of the passage tube 2. In addition, three fluid passages 15 are formed between the respective blades 12 in the inner peripheral direction. These fluid passages 15 and the pore portion 16 are communicated with each other. A fluid introduced from the inlet 7 into the nozzle 3 passes through the fluid passages 15 and the pore portion 16 while the flow thereof is being varied by the blade 12. Subsequently, the fluid is discharged from the outlet 13 into the fluid mixer 1 (mixing portion 11).

Furthermore, the blade 12 may be integrally molded with the nozzle tube 3 or may be separately attached to the inner peripheral surface of the nozzle tube 3 after molding the nozzle tube 3. In the case where the blade 12 is integrally molded with the nozzle tube 3, the molding may be performed so that the blade 12 has a twist angle of approximately 60 or 90 degrees. In addition, in the case where the blade 12 is attached to the nozzle tube 3, any number of blades may be used and the blades are formed so that the twist angle of each of them may be, for example, 30, 45, 60, 90, 120, or 180 degrees.

In the fluid mixer 1 of the present embodiment, the nozzle tube 3 is formed to extend toward the vicinity of the mixing portion 11, so that the flow distance of a fluid in the nozzle tube 3 can be extended. Thus, the negative pressure effect of the fluid in the mixer can be enhanced by increasing the flow rate of the fluid discharged from the outlet 13 of the nozzle tube 3. In this way, the enhanced negative pressure effect of the fluid leads to an increase in volume of a fluid of another type intruded from the inlet pores 5. Furthermore, the fluid may be more finely dispersed, so that the mixing efficiencies of the fluid mixer can be enhanced.

Furthermore, in the fluid mixer 1 of the present embodiment, the varying portion 12 is formed in the nozzle tube 3, so that the flow of a fluid introduced into the mixer 1 through the nozzle tube 3 can be turbulent and varied, thereby facilitating the fluid to be in a state of easily mixing with a fluid of another type. Thus, fluids of different types, such as a gas and a liquid, can be efficiently mixed in a space between the outlet 13 of the nozzle tube 3 and the mixing portion 11, so that the mixing efficiencies of the fluid mixer 1 can be enhanced.

Furthermore, the fluid mixer 1 of the present embodiment is generally formed of a synthetic resin material. Alternatively, the fluid mixer 1 of the present embodiment may be formed of a metal material, such as steel, aluminum, or stainless steel.

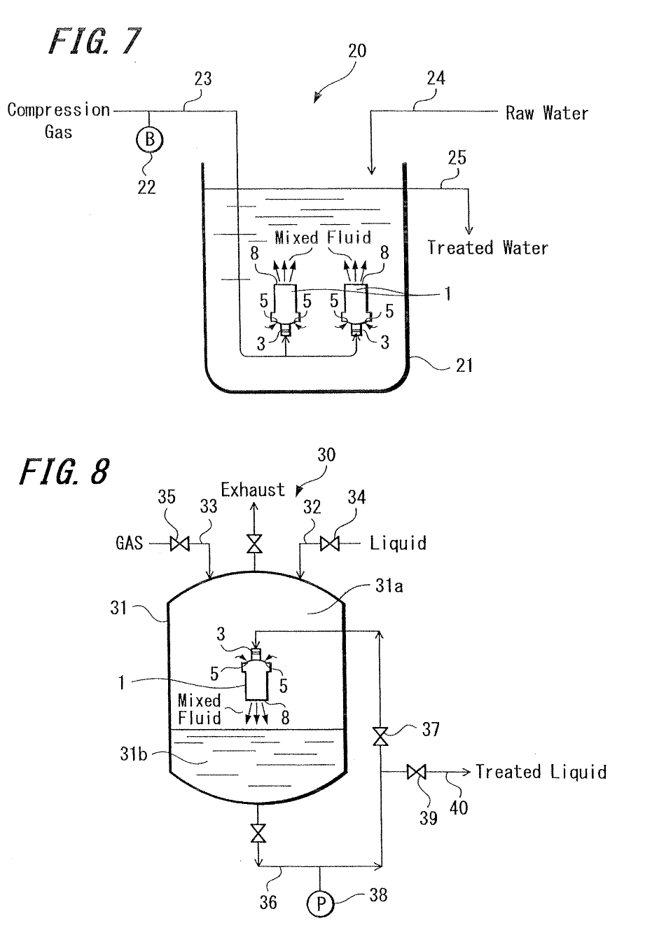

FIG. 7 is a block diagram illustrating a fluid mixing apparatus for carrying out an aeration treatment of activated sludge to which the fluid mixer in accordance with the present invention is applied.

As shown in FIG. 7, in a fluid mixing apparatus 20 of the present embodiment, the bottom of an aerator 21 provided as a second feeding portion in which raw water is stored as a fluid includes two fluid mixers 1 that are arranged in parallel so that their longitudinal directions extend in the vertical direction. In addition, these fluid mixers 1 are arranged so that their nozzle tubes 3 are located at the lower side.

The aerator 21 includes a supply source provided as a first feeding portion for supplying a compressed gas that is a fluid different from raw water, and a gas supplying pipe 23 connected to the supply source mounted on a nozzle tube 3 of the fluid mixer 1. In addition, a blower is installed in the gas supplying pipe 23. The upper part of the aerator 21 includes a raw-water supplying pipe 24 for supplying raw water to the aerator 21 and a treated water discharging pipe 25 for discharging treated water from the aerator 21.

In addition, a threaded hole is formed in the gas supplying pipe 23. A threaded portion 6 formed on the nozzle tube 3 of the fluid mixer 1 is threadably connected to the thread hole to communicate between the gas supplying pipe 23 and the nozzle tube 3.

Furthermore, a compressed gas cylinder may be used instead of the blower 22 to supply a compressed gas of oxygen (O₂), or the like.

Furthermore, the number of fluid mixers 1 placed in the aerator 21 is not limited to two as those in the present embodiment. A single fluid mixer or three or more fluid mixers may be placed.

Next, the operation of the fluid mixing apparatus 20 described above will be described. First, the blower 22 supplies a compressed gas (i.e., a fluid) from a supply source (not shown) through the supplying pipe 23 into the fluid mixers 1 through the nozzle tubes 3, respectively. At this time, the negative pressure effect of the compressed gas thus supplied allows the compressed gas and raw water (i.e., a fluid of another type) in the aerator 21 to be introduced into the fluid mixers 1 through a plurality of inlet pores 5. In each fluid mixer 1, both the raw water and the compressed gas are mixed and stirred in the mixing portion 11 and a gas in the compressed gas may be then dissolved in the raw water. The raw water is subjected to a batch-wise or continuously clarifying treatment with aerobic microorganisms. The raw water is then discharged as treated water from the aerator 21 through the treated water discharging pipe 24.

At this time, the compressed gas introduced in the nozzle tube 3 is sheared by the varying portion 12 of the nozzle tube 3 to vary the flow of the fluid, thereby facilitating the fluid to be easily stirred and mixed with the raw water. Thus, according the fluid mixing apparatus 20 of the present embodiment, in a space between the end of the nozzle tube at the side of the outlet 13 and the mixing portion 11, both the raw water and the compressed gas are sufficiently stirred and mixed to enhance the treatment efficiencies of the fluid mixing apparatus.

FIG. 8 is a block diagram illustrating a fluid mixing apparatus to which the fluid mixture in accordance with the present invention is applied.

In the present embodiment, as shown in FIG. 8, a fluid mixer 1 is placed in an enclosed reaction vessel 31, where the fluid mixer 1 is arranged so that the longitudinal direction thereof extends in the vertical direction. At this time, the fluid mixer 1 is arranged so that the nozzle tube 3 is located above the fluid mixer 1. In this case, the upper part of the reaction vessel 31 includes an introducing portion 31a (space) and the lower part of the reaction vessel 31 includes a storage portion 31b in which the liquid is reserved.

The introducing portion 31a, the upper part of the reaction vessel 31, is connected to a pipe 32 coupled with a liquid supply source. In addition, a flow control valve 34 is installed in the pipe 32. Furthermore, the introducing portion 31a is connected to a pipe 33 connected with a gas supply source. In addition, a flow control valve 35 is installed in the pipe 33. The introducing portion 31a is connected to a pipe 33 connected with a liquid supply source and the gas supply source. From these liquid supply source and the gas supply source, the liquid and the gas are transferred into the reaction vessel 31 (i.e., second feeding portion) under pressure, respectively. In the reaction vessel, a mixed fluid having the liquid and the gas is present in the reaction vessel 31.

In contrast, the storage portion 31b located at the lower part of the reaction vessel 31 is connected to a pipe 36. A liquid (i.e., a fluid) stored in the lower part of the reaction vessel is discharged out of the reaction vessel through the pipe 36.

In addition, the pipe 36 is connected to the nozzle tube 3 of the fluid mixer 1 placed in the space at the upper part of the reaction vessel. A liquid discharged from the bottom of the reaction vessel is supplied to the nozzle tube 3 at the upper part of the reaction vessel through the pipe 36. The pipe 36 includes a threaded hole to which the threaded portion 6 formed on the nozzle tube 3 of the fluid mixer 1 can be threadably attached, thereby communicating between the pipe 36 and the nozzle tube 3.

In this way, the liquid in the reaction vessel 36 is returned to the inside of the reaction and then circulatory supplied to the fluid mixers 1 in the reaction vessel. A first feeding portion is formed such that a pump 38 is installed in the pipe 36 and a flow control valve 37 is also installed therein. Furthermore, a pipe 40 diverges from the upstream of the flow control valve 37 at the middle of the pipe 36 and the pipe 40 includes an on-off valve 30.

Subsequently, the operation of the fluid mixing apparatus 30 as described above will be described.

First, the valve 39 is closed and the valve 37 is opened, while the valves 34 and 35 are respectively opened at predetermined angles to pressure-feed both the liquid and the gas at a predetermined ratio through the pipes 32 and 33. The press-fed liquid and the gas are mixed and stirred in the reaction vessel 31 to sufficiently make a contact between the gas and the liquid to dissolve the gas in the liquid, aerate the liquid, or to promote the reaction of the gas with the liquid.

Furthermore, the liquid stored in the reaction vessel 31 is supplied to the nozzle tube 3 of the fluid mixer 1 mounted on the upper part of the reaction vessel 31 via the pump 38. As a result, a mixed fluid having the liquid and the gas supplied from the pipes 32 and 33 introduced from the inlet pores 5 is mixed with the liquid introduced from the nozzle tube 3 in the fluid mixer 1.

Subsequently, the fluid after the mixing and contact treatments is discharged from the reaction vessel 31 through the pipe 40 by closing the valve 37 and then opening the valve 39.

According to the fluid mixing apparatus 30 of the present embodiment, the liquid of the storage portion 31b introduced into the nozzle tube 3 is sheared by varying portion 12 of the nozzle tube 3, thereby changing flow direction. Accordingly, the fluid is sufficiently stirred and mixed with a mixed fluid of the liquid and the gas of the introducing portion 31a introduced from the inlet pores 5. Thus, in a space between the end of the outlet 13 of the nozzle tube 3 and the mixture section 11, the liquid introduced in the nozzle tube 3 and the mixed fluid introduced from the mixing portion 11 can be sufficiently dissolved and aerated, or the reaction thereof can be promoted, thereby enhancing the treatment efficiencies of the fluid mixing apparatus.

Furthermore, the number of fluid mixers 1 placed in the reaction vessel 31 is not limited to one as that of the present embodiment. Two or more fluid mixers may be arranged in parallel.

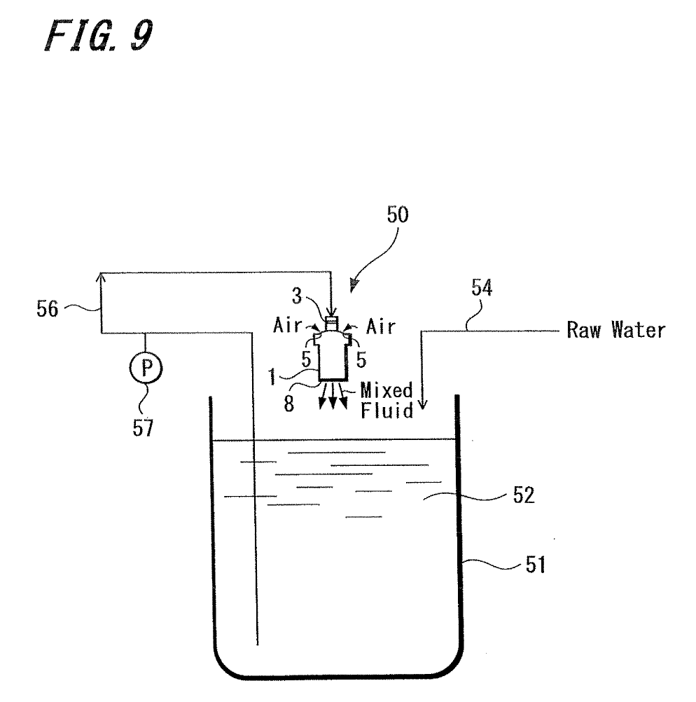

FIG. 9 is a block diagram illustrating a fluid mixing apparatus that carries out an aeration treatment of lake water or the like, to which the fluid mixer of the present invention is applied.

As shown in FIG. 9, in a fluid mixing apparatus 50 of the present embodiment, a fluid mixer 1 is placed above an aerator 51 in which raw water (e.g., lake water) provided as a fluid is stored. The fluid mixer 1 is arranged such that the longitudinal direction thereof is in the vertical direction. Furthermore, the fluid mixer 1 is arranged such that the exhaust 8 is located downward of the fluid mixer 1.

A raw-water supplying pipe 54 for supplying raw water to the aerator 51 is mounted on the upper part of the aerator 51. In this case, the fluid mixer may be directly placed in a pond, a lake, or the like without placing such a raw-water supplying pipe.

A storage portion 52 of the reaction vessel 51 is connected to a pipe 56. In addition, a pump 57 is installed in the pipe 56. Furthermore, the pipe 56 is connected to the nozzle tube 3 of the fluid mixer 1 arranged above the aerator 51 and raw water discharged from the storage portion 52 is then supplied to the nozzle tube 3 of the fluid mixer 1 through the pipe 56.

Furthermore, a threaded hole is formed in the pipe 56. Thus, the threaded portion 6 formed in the nozzle tube 3 of the fluid mixer 1 is threadably attached to the threaded hole to communicate between the pipe 56 and the nozzle tube 3.

Next, the operation of the fluid mixing apparatus 50 as described above will be described. The raw water stored in the aerator 51 is pumped by the pump 57 and supplied to the nozzle tube 3 mounted on the upper part of the aerator 51 by a pump 57. At this time, the negative pressure effect caused in the fluid mixer allows air provided as a fluid to be introduced from the inlet pores 5 and the air is then mixed with raw water introduced from the nozzle tube 3 in the inside (mixing portion) of the fluid mixer 1.

At this time, in the mixing portion 11 of the fluid mixer 1, the air is sufficiently mixed with the raw water while stirring and the air is then sufficiently dissolved in the raw water, thereby enriching dissolved oxygen. For instance, the enriched dissolved oxygen prevents the generation of hydrogen sulfate (H₂S) by anaerobic microorganism in lake water.

According to the fluid mixing apparatus 50 of the present embodiment, the lake water introduced in the nozzle tube 3 from the storage portion 52 is sheared by the varying portion 12 of the nozzle tube 3. As a result, the varied and turbulent streamlines of the lake water may occur. Furthermore, the lake water is facilitated to be easily stirred and mixed with the air introduced from the inlet pores 5. Thus, the lake water introduced in the nozzle tube 3 and the air introduced from the inlet pores 5 can be sufficiently dissolved and aerated, or their reaction can be promoted at a space between the end of the outlet 13 of the nozzle tube 3 and the mixture section 11, thereby enhancing the treatment efficiencies of the fluid mixing apparatus 50.

Furthermore, the number of fluid mixers 1 placed in the reaction vessel 51 is not limited to one as that of the present embodiment. Two or more fluid mixers may be arranged in parallel.

In addition, the fluid mixer and the fluid mixing apparatus of the present invention are not limited to each of the aforementioned embodiments, and it is to be understood by those skilled in the art that various changes and modifications can be made therein without departing from the spirit and the scope of the invention in terms of the material or structure, for example. In particular, the fluids of different types not only include different fluid types such as a liquid, a gas, and a powder fluid but also include, for example, liquids having different properties.

It should be understood by those skilled in the art that various modifications, combinations, sub-combinations and alterations may occur depending on design requirements and other factors insofar as they are within the scope of the appended claims or the equivalents thereof.

What is claimed is:

1. A fluid mixer for mixing fluids of different types, comprising:
a tube member in which a mixing portion for mixing the fluids of different types is installed; and
a nozzle member for introducing a fluid into the tube member, wherein
the nozzle member includes a varying portion for varying a fluid flow.

2. A fluid mixer according to claim 1, wherein
one end of the nozzle member is located in the vicinity of the mixing portion.

3. A fluid mixer according to claim 1 or 2, wherein
the varying portion includes spiral blades provided along an inner peripheral surface of the nozzle member.

4. A fluid mixer according to claim 3, wherein
the number of the spiral blades is two or more.

5. A fluid mixer according to claim 4, wherein
the two or more blades are arranged at equal intervals along the inner peripheral wall of the nozzle member.

6. A fluid mixer according to claim 1, wherein
the tube member includes a pore for introducing the fluid into the tube member.

7. A fluid mixer according to claim 1, further comprising a coupling member to couple the tube member and the nozzle member, wherein
the coupling member includes a pore for introducing fluids thereinto.

8. A fluid mixing apparatus, comprising:
a fluid mixer for mixing fluids of different types;
a first feeding portion for feeding a fluid into the fluid mixer; and
a second feeding portion for feeding a fluid differing in type from the fluid into the fluid mixer, wherein
the fluid mixer includes a tube member in which a mixing portion for mixing the fluids of different types is installed, and a nozzle member for introducing a fluid into the tube member, with the nozzle member having a varying portion for varying a fluid flow.

9. A nozzle member used in a fluid mixer for mixing fluids of different types and for introducing a fluid into the fluid mixer, comprising:
a varying portion for varying a fluid flow, and
an inlet for introducing a fluid into the fluid mixer.

10. The nozzle member according to claim 8, wherein
the varying portion includes spiral blades provided along an inner peripheral surface of the nozzle member.

11. The nozzle member according to claim 9, wherein
the number of the spiral blades is two or more.

12. The nozzle member according to claim 10, wherein
the two or more blades are arranged at equal intervals along the inner peripheral wall of the nozzle member.
